(19) United States
(12) Patent Application Publication
(10) Pub. No.: US 2008/0038837 A1
(43) Pub. Date: Feb. 14, 2008

(54) CHEMICAL TREATMENT CARTRIDGE AND METHOD OF USING SAME

(75) Inventors: Saya SATOU, Tokyo (JP); Takeo TANAAMI, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: YOKOGAWA ELECTRIC CORPORATION, Tokyo (JP)

(21) Appl. No.: 11/837,661

(22) Filed: Aug. 13, 2007

(30) Foreign Application Priority Data
Aug. 11, 2006 (JP) 2006-219444

(51) Int. Cl. B01D 11/00; B01J 19/00; G01N 21/01

(52) U.S. Cl. 436/177; 422/255; 422/82.05

(57) ABSTRACT

There are provided a chemical treatment cartridge capable of easily executing a process for separating constituents from each other, and a method of using the same. The chemical treatment cartridge for transferring liquids contained therein due to deformation occurring thereto upon application of an external force thereto, thereby causing chemical treatment to proceed, wherein the cartridge has an interior comprising an empty space for determining a sequence for the chemical treatment. There are formed, in the interior of the cartridge, a well for receiving a sample from outside and another well where a separation solvent for separating an object constituent contained in the sample as received is mixed with the sample, thereby separating the object constituent contained in the sample from other constituents.

### FIELD OF THE INVENTION

The invention relates to a chemical treatment cartridge for executing separation of an object constituent by transferring contents thereof due to deformation occurring thereto, upon application of an external force thereto, and a method of using the same.

### BACKGROUND OF THE INVENTION

A cartridge for chemical reaction for causing contents thereof to undergo chemical reaction by transferring the contents thereof due to deformation occurring thereto, upon application of an external force thereto, has been under development (for example, disclosed in JP 2005-37368 A). With this cartridge, an empty space for enabling chemical reaction to occur is provided therein, and the contents thereof is caused to undergo a predetermined chemical reaction, due to deformation occurring thereto, upon application of an external force thereto. According to this cartridge, a protocol for chemical reaction can be determined due to a structure itself of the cartridge while a hermetically sealed state is maintained, so that the protocol as desired can be safely executed without a personal error.

### SUMMARY OF THE INVENTION

When attempting to obtain an object substance through chemical reaction, there will be, in general, the needs for a series of operations such as preparation of laboratory wares and reagents, to start with, followed by work for starting the chemical reaction, determination on completion of the chemical reaction, isolation of the object substance from reacted reagents, unreacted substances, and by-products, identification/measurements of reactants, and so forth. In carrying out those operations, use of expensive wares is required, and also, in saving time and work amounts, techniques are required. Furthermore, as is often the case, there will be the case where noxious substances are used as the reagents, or the case where evolution of noxious gasses occurs due to the chemical reaction,

FIG. 11 shows an operation procedure necessary for bromination reaction of p-xylene at benzyl position by use of N-bromossuccinimide (NBS). It is required that this reaction includes steps such as step (1) whereby p-xylene is dissolved in a solvent of carbon tetrachloride (CCl₄), step (2) whereby N-bromossuccinimide (NBS) as a reagent is added thereto to be dissolved, step (3) whereby a radical initiator {α,α′-azobis (isobutyronitrile)} AIBN is added thereto for homogeneous dispersion, steps (4) (5) for heating due to boiling-point refluxing, and precipitation of succinic acid, step (6) for removal of succinic acid, step (7) for deactivation of bromine due to addition of sodium sulfite, step (8) for extraction of a separated liquid by mixing with chloroform, step (9) for dehydration due to addition of sodium sulfate, step (10) for recrystallization due to dissolution in methanol, step (11) for isolation by a silica chromatography, step (12) for vacuum concentration by an evaporator, and so forth. Further, in order to observe a reaction process, there is the need for operations whereby reacted liquids heated up by the boiling point refluxing are sequentially take out to thereby extract the separated liquid, whereupon reactants are analyzed and measured. In addition, there is the need for applying an operation, such as analysis and so forth, to final products as well.

As the operations concerning separation of constituents, in particular, such as extraction and analysis of the separated liquid, and so forth, are complicated among those steps described as above, if any means for efficiently executing the operations is available, this will be useful in testing. Further, as products according to the present example has a lachrymatory action, such means will be useful in ensuring safety of worker conducting the testing. Furthermore, the means will be useful in preparation of chemical constituents for drugs, reagents, and others.

It is therefore an object of the invention to provide a cartridge for chemical treatment, capable of easily executing a process for separating constituents from each other by taking advantage of a technology disclosed in JP 2005-37368 A, and so forth, and a method of using the same.

In accordance with one aspect of the invention, there is provided a chemical treatment cartridge for causing chemical treatment to proceed by transferring liquids contained therein due to deformation occurring thereto upon application of an external force thereto, wherein said cartridge has an interior which is characterized in comprising an empty space for receiving a sample from outside, and an empty space where a separation solvent for separating an object constituent contained in the sample as received is mixed with the sample, thereby separating the object constituent contained in the sample from other constituents.

With the chemical treatment cartridge described as above, since there is provided the empty space where the separation solvent for separating the object constituent contained in the sample as received is mixed with the sample, thereby separating the object constituent contained in the sample from other constituents, the object constituent can be easily separated from other constituents.

The interior of the cartridge may further comprise an empty space for causing reaction of the sample received from the outside to be stopped.

Still further, the interior of the cartridge may comprise an empty space for enriching the object constituent separated by the separation solvent.

The object constituent may be enriched due to evaporation of the solvent.

Yet further, the interior of the cartridge may comprise an empty space for adding a dissolution agent to the enriched object constituent.

Further, the interior of the cartridge may comprise an empty space for causing the object constituent to undergo recrystallization after addition of the dissolution agent.

The object constituent may be caused to undergo recrystallization due to evaporation of the dissolution agent, saturation accompanying cooling of the dissolution agent, or addition of a low solubility solvent.

Still further the interior of the cartridge may comprise an empty space for cleaning the re-crystallized object constituent.

Yet further, the interior of the cartridge may comprise a column for refining the object constituent by a chromatography after the addition of the dissolution agent.

Empty spaces for accommodating respective constituents discharged from the column on a split time basis may be formed.

The cartridge described as above may be provided with an optical window for measurement, for executing optical measurement on contents of the cartridge.

The interior of the cartridge described as above may comprise a plurality of predetermined structures formed so as to determine an identical sequence for the chemical treatment.

The interior of the cartridge may comprise flow paths for branching the sample as received into the plurality of the predetermined structures.

In the empty space where the object constituent contained in the sample is separated from other constituents, an oil layer may be separated from a water layer by the agency of gravity.

In the empty space where the object constituent contained in the sample is separated from other constituents, the internal surface of the empty space may be provided with two regions differing from each other in respect of affinity against the object constituent, thereby effecting separation of the object constituent from other constituents.

In accordance with another aspect of the invention, there is provided a method of using a chemical treatment cartridge for causing chemical treatment to proceed by transferring liquids contained therein due to deformation occurring thereto upon application of an external force thereto, said method is characterized in comprising a step of mixing a hydrophilic solvent, and a hydrophobic solvent, for separating an object constituent contained in a received sample, with the sample, in an empty space formed in the interior thereof, thereby separating the object constituent contained in the sample from other constituents, and a step of discarding the cartridge used in the step of separating the object constituent contained in the sample from other constituents.

With the method of using a chemical treatment cartridge, according to the invention, since the hydrophilic solvent, and the hydrophobic solvent, for separating the object constituent contained in the sample, are mixed with the sample, in the empty space in the interior thereof, thereby separating the object constituent contained in the sample from other constituents, the object constituent contained in the sample can be easily separated from other constituents. Further, since the cartridge used in the step of separating the object constituent contained in the sample from other constituents is discarded, post-operation works such as tidying-up, cleaning, or the like will be no longer necessary while safety can be ensured.

### BRIEF DESCRIPTION OF THE DRAWINGS

FIG. 1 is a view showing a construction of a chemical treatment cartridge according to one of working examples of the invention, in which FIG. 1(A) is a plan view showing the construction of the chemical treating cartridge, FIG. 1(B) is a sectional view taken on line 1b-1b in FIG. 1(A), and FIG. 1(C) is a plan view showing a method of using the chemical treating cartridge;

FIG. 2(A) is a plan view showing a construction and so forth of a cartridge from which the flow path for discharging an object substance is removed, out of which FIG. 2(A) is a plan view, and FIG. 2(B) is a plan view showing an operation for recovering a solution in the under layer;

FIG. 3(A) is schematic illustration showing a procedure for extraction of an object substance and refining, out of which FIGS. 3(A) to 3(C) are schematic illustration showing a procedure whereby an object substance is extracted by the extraction of a separated liquid with the use of a cartridge 10A, and a recrystallization cartridge, and further refining the object substance;

FIG. 4 is a plan view showing a configuration of a silica column cartridge, wherein FIG. 4(A) shows a case of transferring liquid by pressure, and FIG. 4(B) shows a case of transferring liquid by gravity;

FIG. 5 is a view of a example of a silica column cartridge 50A provided with a well for accommodating a waste liquid;

FIG. 6 is a plan view showing a configuration of a cartridge capable of executing a process from the start of reaction through refining;

FIG. 7 is a plan view showing a configuration of a cartridge capable of coping with the case where all reagents are solution-based;

FIG. 8 is a plan view showing a configuration of a cartridge suitable for sampling reactants;

FIG. 9 is a plan view showing a configuration of a cartridge in which flow paths provided with filters having dehydration capacity, respectively, are formed therein;

FIG. 10 is a view showing an example where a cartridge is provided with an optical window for measurement, wherein FIG. 10(A) is a plan view of the cartridge, and FIG. 10(B) is a sectional view thereof; and

FIG. 11 is a view showing an operation procedure necessary for bromination reaction of p-xylene at benzyl position by use of N-bromossuccinimide (NBS).

### PREFERRED EMBODIMENTS OF THE INVENTION

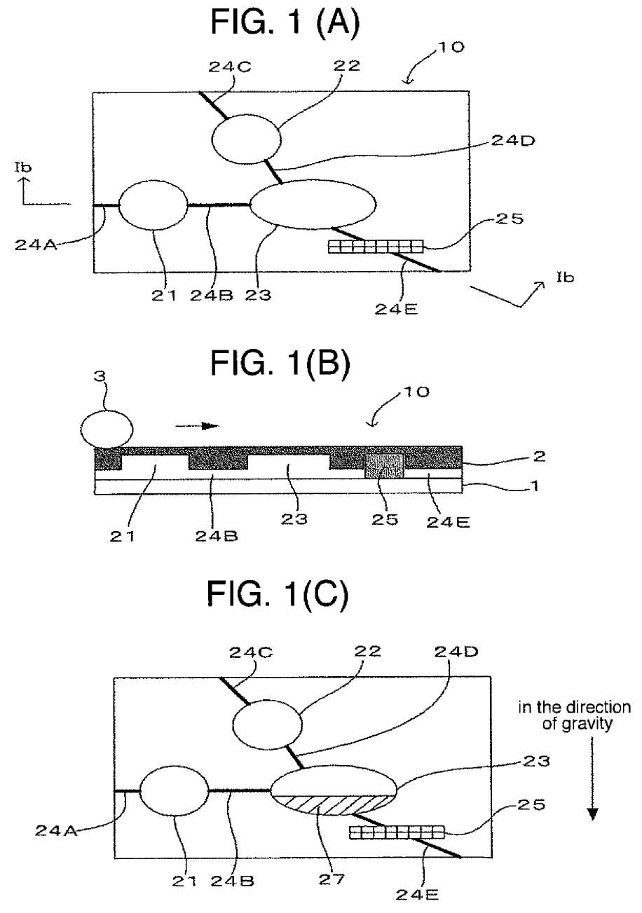

Embodiments of a chemical treatment cartridge according to the invention are described hereinafter with reference to accompanying drawings. FIG. 1(A) is a plan view of the chemical treatment cartridge according to one of the embodiments, FIG. 1(B) is a sectional view taken on line 1b-1b in FIG. 1(A), along wells and flow paths, respectively, and FIG. 1(C) is a plan view showing a method of using the cartridge.

As shown in FIG. 1(A), the cartridge 10 comprises a substrate 1 and an elastic member 2 overlaid on the substrate 1.

Recesses in predetermined shapes, respectively, depressed toward the top surface of the elastic member 2 (toward an upper surface side, in FIG. 1(B) are formed on the back surface (the underside surface in FIG. 1(B) of the elastic member 2. Those recesses create empty spaces between the substrate 1 and the elastic member 2, thereby making up a well 21 for receiving a reacted liquid, a well 22 for accommodating a separation solvent, and a well 23 for mixing the reacted liquid with the separation solvent, a flow path 24A interconnecting a side face of the cartridge 10 and the well 21, a flow path 24B interconnecting the well 21 and well 22, a flow path 24C interconnecting a side face of the cartridge 10 and the well 22, a flow path 24D interconnecting the well 22 and the well 23, a flow path 24E interconnecting a side face of the cartridge 10 and the well 23 as shown in FIGS. 1(A) and 1(B). Further, a filter 25 having dehydration capacity equivalent to that of magnesium sulfate is disposed in the flow path 24E.

Subsequently, the method of using the cartridge is described hereinafter.

To start with, the reacted liquid is injected into the well 21 via the flow path 24A by use of a syringe or like. Further, the separation solvent is injected into the well 22 via the flow path 24C by use of a syringe or like.

Next, when a roller 3 shown in FIG. 1(B) is pressed against the cartridge 10, the elastic member 2 undergoes elastic deformation, thereby crushing the respective empty spaces between the substrate 1 and the elastic member 2. Upon rightward rotation of the roller 3, a region to be crushed will be shifted rightward, whereupon the reacted liquid contained in the well 21 is shifted via the flow path 24B, and the separation solvent contained in the well 22 is shifted via the flow path 24D, respectively, thereby reaching the well 23.

Next, in FIG. 1(B), by shifting the roller 3 from side to side, the reacted liquid, and the separation solvent is intensely mixed with each other in the well 23.

Next, as shown in FIG. 1(C), if mixed liquids are kept in still standing with the cartridge 10 held in the perpendicular direction, this will cause the mixed liquids to be separated into an upper layer (e.g. a water layer), and a lower layer (e.g. a chloroform layer) by the agency of the gravity.

Then, if the roller 3 in FIG. 1(C) is shifted rightward, this will cause a hydrophobic solution 27 in the under layer shifting in the flow path 24B to pass through a filter 25 to be dehydrated before recovery. The cartridge 10, as it is, can be discarded.

With a chemical treatment method described as above, since operations necessary for the treatment have been predetermined on the basis of a shape of the cartridge 10, reliable operations are enabled without being affected by workmanship of a workman. Further, if driving, and so forth of the roller 3 are automated, this will enable automation of the chemical treatment.

With the chemical treatment method described as above, a product is separated from a reactive reagent by addition of the separation solvent, thereby stopping reactions. By execution of a series of operations at a predetermined timing, respectively, time until a reaction stop in respective stages can be held constant. Further, injection quantities of the reacted liquid, and the separation solvent can be easily controlled to a constant quantity, respectively, even though small in quantity, thereby controlling respective added volumes, so that the chemical treatment can be stoichiometrically controlled and the product as separated can also be used for quantification application.

Further, since it is possible to execute the chemical treatment with the cartridge 10 in as-hermetically sealed state to thereby discard the same, it is possible to avoid contamination from outside, and contamination due to cleaning or reuse of a container. Still further, because leakage of noxious substances can be prevented, the chemical treatment can be safely carried out. Yet further, with the chemical treatment method described as above, it is possible to easily cope with chemical treatment against a small quantity than in the case of using testing wares, so that, for example, a use amount of a precious reagent can be checked.

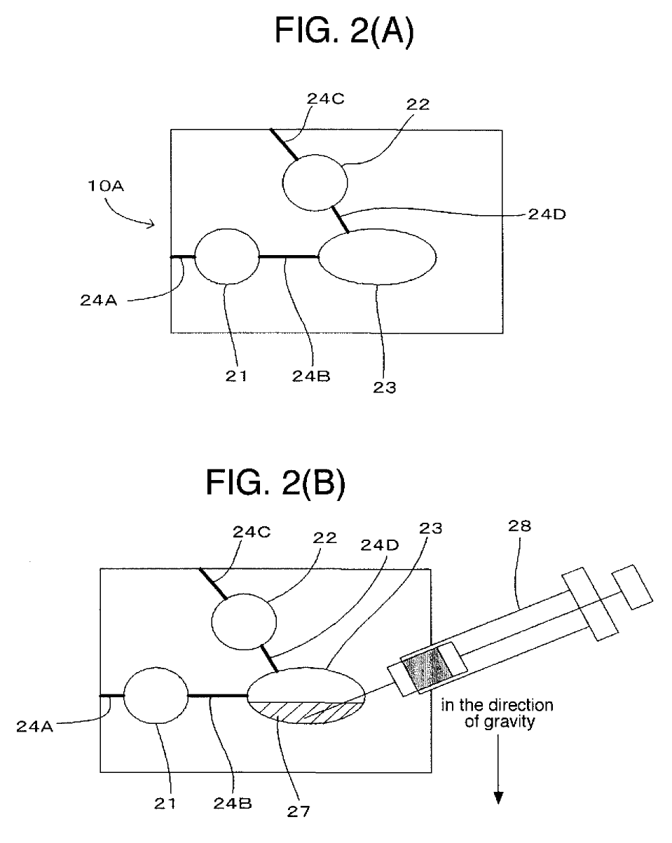

FIG. 2(A) is a plan view showing a cartridge 10A from which the flow path for discharging an object substance is removed. In this case, the hydrophobic solution 27 in the under layer can be recovered from the cartridge 10A by use a syringe 28, and so forth, as shown in FIG. 2(B). An operation procedure in other respects is the same as that for the case of using the cartridge 10.

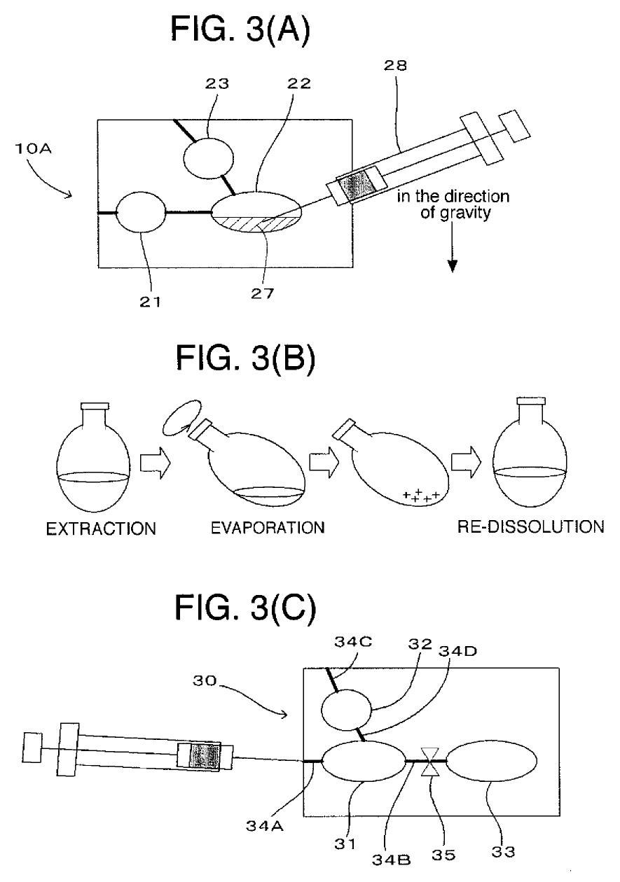

FIGS. 3A to 3C are schematic illustration showing a procedure whereby an object substance is extracted by the extraction of the separated liquid, and the object substance is subjected to recrystallization to be refined with the use of the cartridge 10A, and a recrystallization cartridge.

As shown in FIG. 3(C), with the recrystallization cartridge 30, there are formed a well 31 for receiving a dissolution sample, a well 32 for containing a cleaning liquid, and a well 33 for containing a waste liquid. Further, there are formed a flow path 34A between a well 31 and a side face of the recrystallization cartridge 30, a flow path 34B between the well 31 and a well 33, a flow path 34C between a well 32 and a side face of the recrystallization cartridge 30, and a flow path 34D between the well 32, and the well 31.

In addition, the flow path 34B is provided with a region functioning as a valve 35. The valve 35 is closed by, for example, pressing down the cartridge 39 by an appropriate member so as to be crush the flow path 34B, and it is normally kept open.

Next, an operation procedure for extracting the object substance to be then refined will be described hereinafter.

After the solutions are separated from each other according to the operation procedure described in the foregoing, the hydrophobic solution 27 in the under layer is recovered from a well 22 in the cartridge 10A by use of the syringe 28. Then, as shown in FIG. 3(B), the solution is subjected to concentration or caking with the use of an evaporator to be thereby re-dissolved into a solvent for recrystallization such as methanol (dissolving agent).

Subsequently, the dissolution sample as re-dissolved is injected into the recrystallization cartridge 30, thereby causing the object substance to be refined.

First, as shown in FIG. 3(C), the dissolution sample described is injected into the well 31 with the valve 35 kept in as-closed state via the flow path 34A. A solvent in the dissolution sample within the well 31 will be gently evaporated over time due to permeability of the recrystallization cartridge 30 formed of PDMS (polydimethylsiloxane), and so forth, thereby precipitating crystals. Evaporation of the solvent may be promoted by heating the well 31, or the solvent may be evaporated at normal temperature. Otherwise, the well 31 may be cooled, thereby causing the object substance to be saturated in the solvent, resulting in crystallization.

Next, the cleaning liquid in the well 32 is guided into the well 31 by use of a roller, and so forth, thereby cleaning surfaces of the crystals. For the cleaning liquid, use is made of the same solvent as the solvent for recrystallization. The cleaning liquid in the well 31 is transferred by use of the rollere, and so forth to the flow path 34B with the valve 35 kept in as-opened state to be subsequently discarded into the well 33.

The object substance is recovered as the crystals remaining in the well 31. The crystals can be taken out by, for example, cutting the recrystallization cartridge 30.

Thus, with the use of the recrystallization cartridge 30, the object substance can be refined by a simple operation.

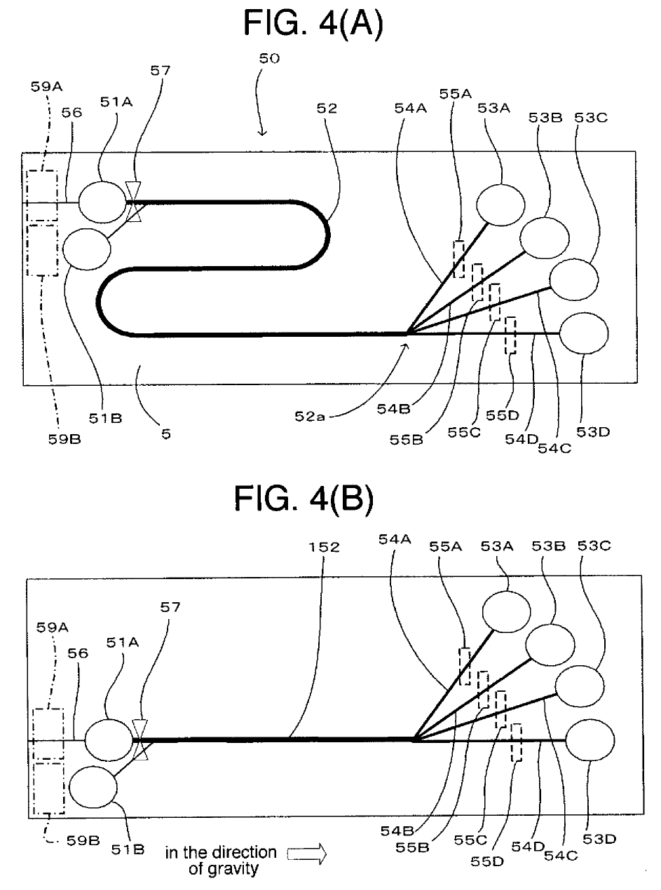

FIG. 4(A) is a plan view showing a configuration of a silica column cartridge. With the use of this cartridge, an object substance obtained by extraction of a separated liquid can be isolated and refined by a simple operation.

As shown in FIG. 4(A), a silica column cartridge 50 comprises a substrate (not shown), and an elastic member 5 to be overlaid on the substrate 1.

Recesses in predetermined shapes, respectively, are formed on the back surface of the elastic member 5. Those recesses create empty spaces between the substrate, and the elastic member 5, whereupon, as shown in FIG. 4(A), there are formed a well 51A for receiving a sample, a well 51B for holding a developing solvent, a column 52 filled up with silica particles, wells 53A, 53B, 53C and 53D, for accommodating respective constituents separated by the column 52, respectively, flow paths 54A, 54B, 54C, 54D for connecting the column 52 to the wells 53A, 53B, 53C, and 53D, respectively, and a flow path 56 for connecting a side face of the cartridge 50 and the well 51A.

Next, there is described hereinafter an isolation and refining method using the silica column cartridge 50 of a normal phase.

A dissolution sample after re-dissolved is prepared by the procedure for operation shown in FIGS. 3(A) and 3(B).

First, the dissolution sample after re-dissolved is injected into the well 51A via the flow path 56 by use of a syringe or the like. At this point in time, the flow paths 54A, 54B, 54C, 54D are closed by valve members 55A, 55B, 55C, 55D, respectively.

Next, with a valve member 57 kept in such a state as pressed-down to the cartridge 50, a roller 59A in a state as pressed-down to the cartridge 50 is shifted in position from the well 51A toward the valve member 57, thereby causing the sample of the well 51A to be adsorbed to the silica particles with fine bands, respectively.

Then, the valve members 57 and 55A are released from the cartridge 50, whereupon the fine bands of the well 51A will proceed under a predetermined pressure applied by the roller 59A that is pressed down to the cartridge 50. By causing a roller 59B to transfer the developing solvent in the well 51B, the predetermined pressure against the sample can be maintained.

The sample under the pressure moves ahead inside the column 52, and there occurs separation of respective constituents of the sample by the chromatography, according to a difference in affinity, particularly, according to a difference in polarity, in this case, among the respective constituents.

When a first constituent to be extracted has reached a terminal point 52a of the column 52 (FIG. 4(A)), the valve member 55A is shifted to thereby render only the flow path 54A passable, and the first constituent having reached the terminal point 52a is guided into the well 53A via the flow path 54A. Thereafter, the flow path 54A is again closed by the valve member 55A.

Next, the valve member 55B is released and when a second constituent to be extracted has reached the terminal point 52a of the column 52, the valve member 55B is shifted to thereby render only the flow path 54B passable, and the second constituent having reached the terminal point 52a is guided into the well 53B via the flow path 54B. Thereafter, the flow path 54B is again closed by the valve member 55B.

Thus, by repeating a procedure for changing over the flow path by splitting time, it becomes possible to sequentially guide the respective constituents to be sequentially extracted, that is, constituents high in decreasing order of Rf value into the wells 53A, 53B, 53C, and 53D, respectively. The respective constituents extracted in the wells 53A, 53B, 53C, and 53D, respectively, can be collected or obtained by use of a syringe or the like.

Further, there is eliminated the risk of the silica particles filled in the column 52 being scattered because the cartridge 50 is to be thrown away, thereby enabling safety to be ensured. Furthermore, since a cartridge is used for carrying out a chemical treatment, the column 52 can be reduced in size, thereby enabling usage of the silica particles to be checked.

With a working example shown in FIG. 4(A), the sample is transferred by pressure, however, the column may alternatively be configured or disposed in a direction in which gravity acts such that the sample is transferred by the agency of the gravity.

FIG. 4(B) is a plan view showing a configuration of a cartridge comprising a column formed along a direction in which gravity acts. With this cartridge, a straight-line column 152 is formed in place of the column 52 in FIG. 4(A). In the case of the cartridge described, a sample adsorbed to the column 152 undergoes development by the developing solvent transferred from the well 51B by the agency of gravity. By the same procedure as that for the case shown in FIG. 4(A), respective constituents to be sequentially extracted, that is, constituents high in decreasing order of Rf value can be sequentially guided into wells 53A, 53B, 53C 53D, respectively.

With the cartridge shown in FIG. 4(B) as well, the roller 59A and the roller 59B may be used in combination as appropriate as with the case of FIG. 4(A). Further, if the wells 53A, 53B, 53C, and 53D are kept in a vacuum state, respectively, in advance, this will enable the respective constituents to be extracted to be easily guided into the respective wells. Furthermore, with the wells 53A, 53B, 53C, and 53D, kept in a vacuum state, respectively, in advance, not only gravity but also suction force of the elastic member, due to restoring force thereof, may be utilized to thereby contain the respective constituents. The same applied to the cartridge 50 shown in FIG. 4(A).

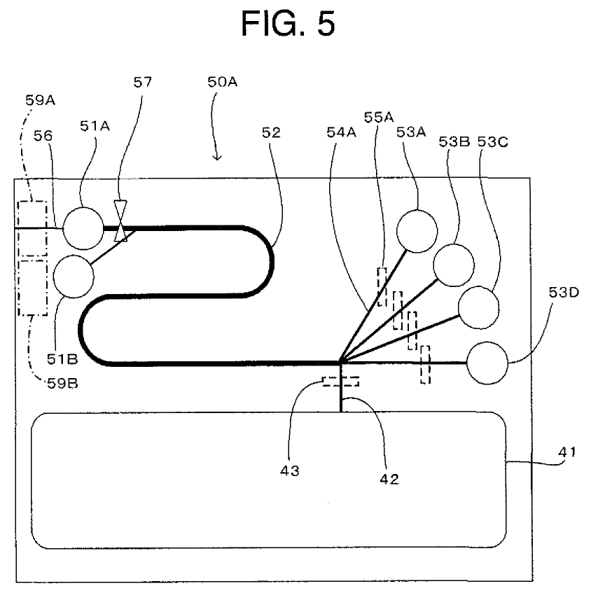

FIG. 5 is a plan view of a working example of a silica column cartridge 50A provided with a well 41 for accommodating a waste liquid.

With the silica column cartridge 50A shown in FIG. 5, the well 41 is connected to a terminal point of a column 52 via a flow path 42. The flow path 42 is opened or closed by a valve member 43. When extraction of constituents, into wells 53A, 53B, 53C, and 53D, respectively, is not executed, an unnecessary liquid (waste liquid) can be guided into the well 41 by opening the flow path 42. The waste liquid, together with the cartridge 50A, can be discarded.

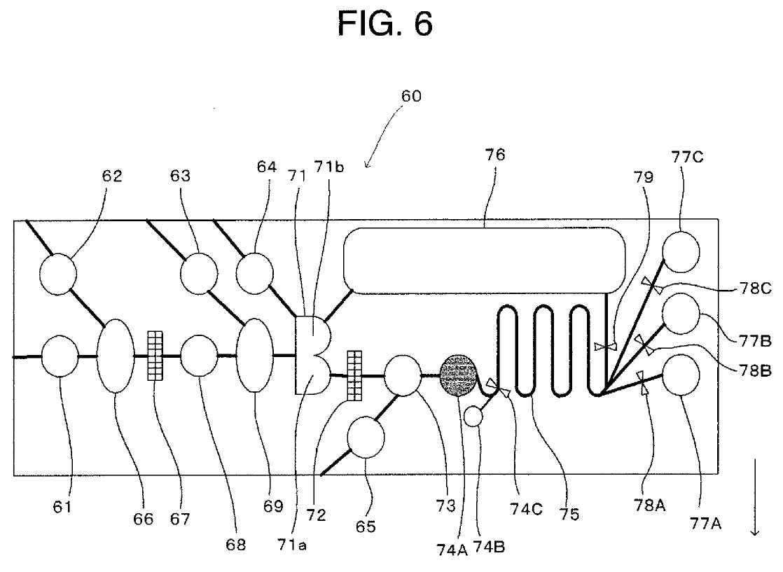

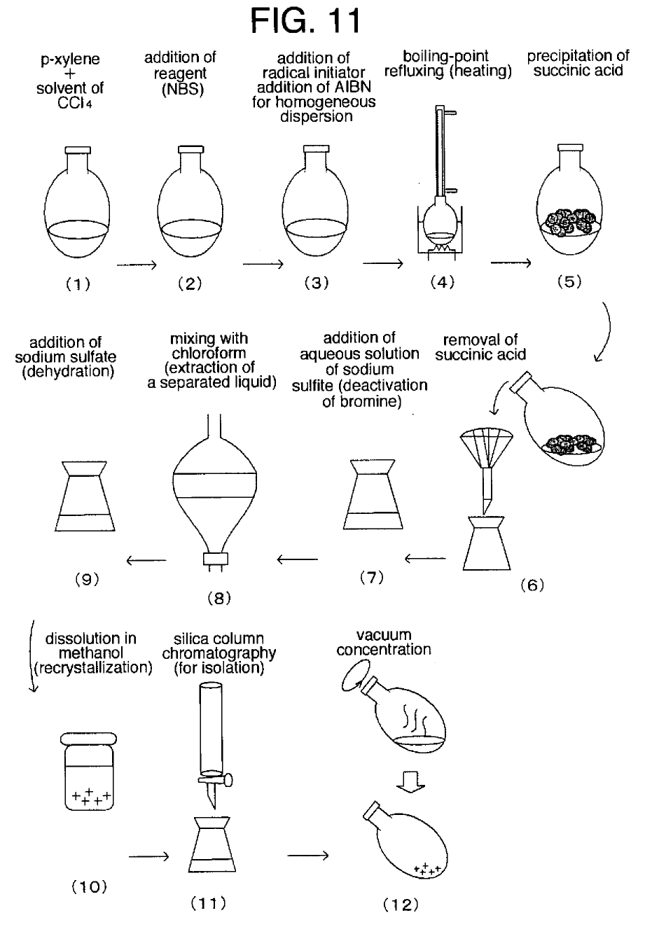

Now, FIG. 6 is a plan view showing a configuration of a cartridge capable of executing a process from the start of reaction through refining. FIG. 6 shows the cartridge for executing the operation procedure shown in FIG. 11.

Before starting the reaction, p-xylene is injected into a well 61, carbon tetrachloride (CCl₄) as a solvent is injected into a well 62, an aqueous solution of sodium sulfite (Na₂S₂O₄) as a quencher is injected into a well 63, chloroform as a solvent for liquid separation is injected into a well 64, and a solvent for the silica chromatography is injected into a well 65, respectively. Further, pre-pelletized N-bromossuccinimide (NBS) and {α-α′-azobis(isobutyronitrile)} (AIBN) as an initiator are contained in a well 66 at the time of manufacturing a cartridge 60.

Subsequently, a procedure for operating the cartridge 60 is described hereinafter.

With the use of a roller, and so forth, p-xylene in the well 61, and the solvent in the well 62 are guided into a well 66. Further, the roller, and so forth are reciprocatively driven to thereby cause N-bromossuccinimide (NBS) to undergo homogeneous dispersion into a liquid, and the well 62 is heated with the use of a Peltier element or the like, thereby causing the start of the reaction.

A reaction solution and succinic acid as precipitated remain in the cell 66 upon completion of the reaction. Next, with the use of the roller, and so forth, the contents of the cell 66 are transferred and passed through a filter 67 formed of glass fiber, or the like whereupon succinic acid is removed, and the reaction solution is transferred to a well 68. Then, with the use of the roller and so forth, the reaction solution in the well 68, and the quencher in the well 63 are transferred to a well 69 where mixing is carried out to thereby cause deactivation of bromine as produced.

Next, with the use of the roller, and so forth, the contents of the well 69, and the solvent for liquid separation in the well 64 are guided into a well 71 where intense mixing is caused to occur due to the reciprocative motions of the roller and so forth. Thereafter, the cartridge 60 is kept standing still, whereupon the contents of the well 71 are separated into a water layer (lower layer), and an oil layer (upper layer) by the agency of gravity.

Then, with the use of the roller, and so forth, the water layer of the well 71 is discarded into a well 76, and the oil layer of the well 71 is guided into a well 73 after passing through a dehydration filter 72 equivalent in function to sodium sulfate. Then, the well 73 is heated to thereby enrich a solution, and subsequently, the developing solvent in the well 65 is guided into the well 73.

Next, a solution of the well 73 is slowly transferred to a silica column well 74A, and after the solution is adsorbed to the silica column well 74A, a developing solvent inside a well 74B is roller-transferred, and by closing a valve 74C, a predetermined pressure is applied thereto, thereby executing pressure-transfer of a solution in a swelling silica flow path 75. By so doing, the solution being transferred through the swelling silica flow path 75 undergoes separation in constituent according to a difference in affinity, in this case, a difference in polarity.

Thereafter, valves 78A, 78B, 78C, and 79 are selectively opened at an appropriate time to thereby enable a constituent high in Rf value to be recovered into wells 77A, 77B, and 77C, respectively, while discarding an unnecessary constituent into a well 76. This procedure is similar to the procedure adopted in the cartridge shown in FIG. 4 or FIG. 5. The constituents recovered in the wells 77A, 77B, and 77C, respectively, can be extracted by use of a syringe or like.

In place of liquid separation by the agency of gravity, liquid separation can be implemented by providing the well 71 with a hydrophilic region and a hydrophobic region. If, for example, a region 71a of the well 71 in FIG. 6 is worked so as to be hydrophilic while a region 71b thereof is worked so as to be hydrophobic, the contents guided into the well 71 is separated into the water layer in the region 71a, and the oil layer in the region 71b.

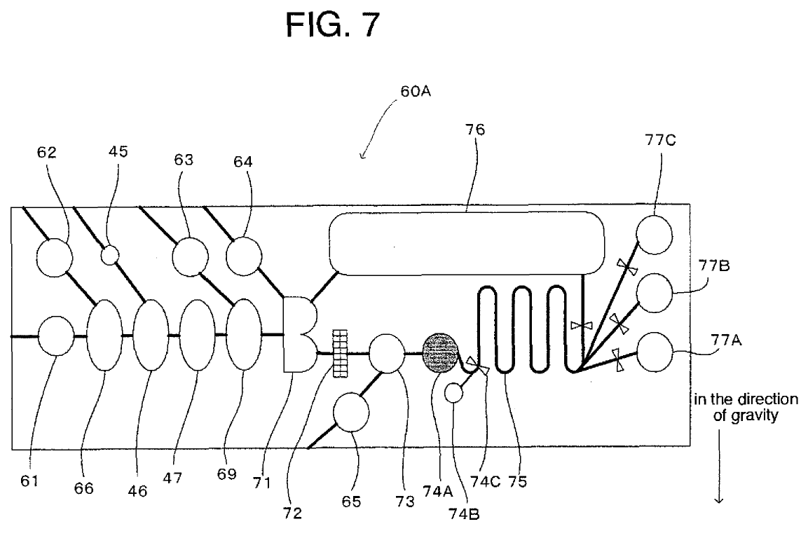

FIG. 7 is a plan view showing a configuration of a cartridge capable of coping with the case where all reagents are solution-based. A cartridge 60A shown in FIG. 7 is capable of executing the same process as is executed by the cartridge 60 shown in FIG. 6.

Before starting a reaction, p-xylene is injected into a well 61, a carbon tetrachloride (CCl₄) solution of N-bromossuccinimide (NBS) as a reagent is injected into a well 62, an aqueous solution of sodium sulfite (Na₂S₂O₄) as a quencher is injected into a well 63, chloroform as a solvent for liquid separation is injected into a well 64, and a solvent for the silica chromatography is injected into a well 65, respectively. Further, α-α′-azobis(isobutyronitrile) (AIBN) as an initiator is injected into a well 45.

Next, a procedure for operating the cartridge 60A is described hereinafter.

With the use of a roller, and so forth, p-xylene in the well 61, and the reagent in the well 62 are guided into a well 66. Further, with the roller, and so forth being moved, the contents of the well 66 and the initiator are mixed in a well 46 before being transferred to a well 47.

Then, the well 47 is heated with the use of a Peltier element or the like, thereby causing the start of a reaction.

With the use of the roller, and so forth, a reaction solution of the well 47, and the quencher of the well 63 are transferred upon completion of the reaction to a well 69 where mixing is carried out to thereby cause deactivation of bromine as produced.

Next, with the use of the roller, and so forth, the contents of the well 69, and the solvent for liquid separation in the well 64 are guided into a well 71 where intense mixing is caused to occur due to the reciprocative motions of the roller, and so forth. Thereafter, the cartridge 60A is kept standing still, whereupon the contents of the well 71 are separated into a water layer (lower layer), and an oil layer (upper layer) by the agency of gravity.

Then, with the use of the roller and so forth, the water layer of the well 71 is discarded into a well 76, and the oil layer of the well 71 is guided into a well 73 after passing through a dehydration filter 72 equivalent in function to sodium sulfate. Then, the well 73 is heated to thereby enrich a solution, and subsequently, the solvent for the silica chromatography, contained in the well 65, is guided into the well 73.

Next, a solution of the well 73 is slowly transferred to a silica column well 74A, and after the solution is adsorbed to the silica column well 74A, a developing solvent inside a well 74B is roller-transferred, and by closing a valve 74C, a predetermined pressure is applied thereto, thereby executing pressure-transfer of a solution in a swelling silica flow path 75. By so doing, the solution being transferred through the swelling silica flow path 75 undergoes separation in constituent according to a difference in affinity, in this case, a difference in polarity.

Thereafter, the same operation as in the case of the cartridge 60 is executed to thereby enable a constituent high in Rf value to be recovered into wells 77A, 77B, and 77C, respectively, while discarding an unnecessary constituent into the well 76. The constituents recovered in the wells 77A, 77B, and 77C, respectively, can be collected or obtained by use of a syringe or like.

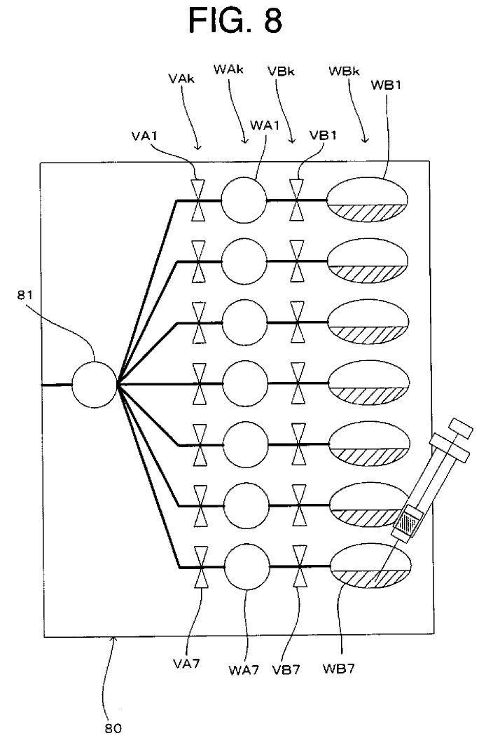

FIG. 8 is a plan view showing a configuration of a cartridge 80 suitable for sampling reactants in order to observe a reaction process. With the cartridge 80, there are shown a plurality of structures for liquid separation, formed so as to be in array.

As shown in FIG. 8, the cartridge 80 comprises a well 81, wells connected thereto WAk, and wells connected thereto WBk. Further, there are provided a valve VAk between the well 81, and the respective wells WAk, and a valve VBk between the respective wells WAk, and the respective wells WBk. Herein, an adscript “k” represents integers 1 to 7.

Next, there is described hereinafter a method of using the cartridge 80.

First, the valve VA1 is opened while closing the valves VA2 to VA7, and with the valve VB1 in closed state, a solvent for liquid separation is injected into the well 81. Next, liquid transfer of the solvent for liquid separation to the well WA1 is executed with the use of the roller, and so forth, whereupon the valve VA1 is closed. The well WA1 is filled up with the solvent for liquid separation.

The same operation as above is repeated with respect to the respective wells WAk (k=2 to 7), thereby filling up the wells WA2 to WA7 with the solvent for liquid separation.

A solution sample for observation of the reaction process is injected into the well 81. After injection of a first sample solution into the well 81, the valves VA1, VB1 are opened, and with the valves VA2 to VA7, being kept in closed state, liquid transfer is executed with the use of the roller, and so forth. The solution sample of the well 81, together with the solvent for liquid separation, contained in the well WA1, is guided into the well WB1. Further, an water layer and an oil layer are intensely mixed with each other by causing the roller, and so to undergo reciprocative motions.

By closing the valve VB1, and keeping a mixture standing still, the mixture inside the well WB1 is separated into a solvent relatively large in density at a lower layer, and a solvent relatively small in density at an upper layer either by the agency of gravity, or according to a difference in affinity between a hydrophilic coating region and a hydrophobic coating region, on the internal surface of the well.

A reaction process on the first sample solution can be examined by recovering the oil layer containing reactants with the use of a syringe or the like.

By repeating the same operation as above with respect to the respective wells WBk (k=2 to 7), it is possible to recover reactant from the wells WB2 to WB7, respectively.

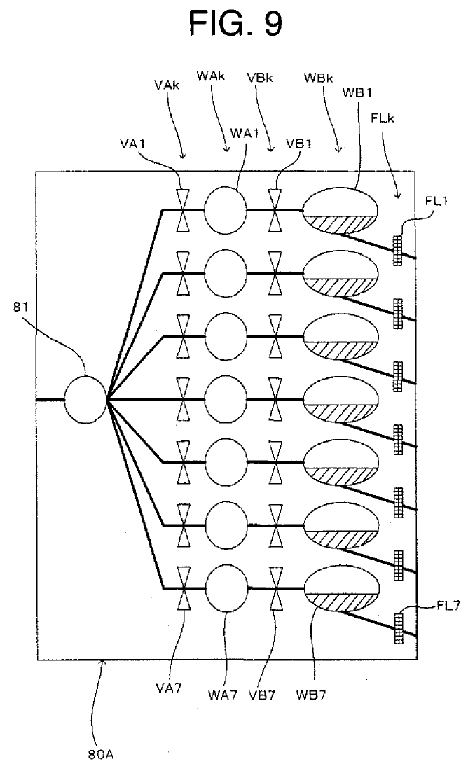

With a cartridge 80A shown in FIG. 9, flow paths provided with filters FL1 to FL7 having dehydration capacity, respectively, are formed therein. When use is made of the cartridge 80A, reactant can be recovered to the outside thereof via the filters FL1 to FL7, respectively.

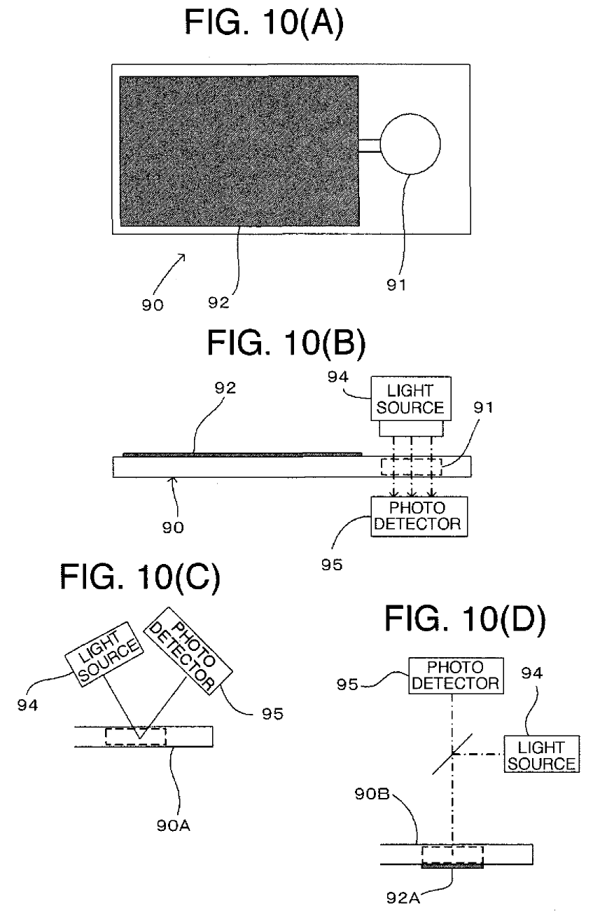

FIG. 10 shows an example where a cartridge 90 according to the invention is provided with an optical window for measurement, of which FIG. 10(A) is a plan view of the cartridge, and FIG. 10(B) is a sectional view thereof.

As shown in FIGS. 10(A) and 10(B), a well 91 for containing a refined sample is formed in the cartridge 90. The cartridge 90 is made up such that a region of the well 91 serves as the optical window for measurement, and it is possible to execute optical measurement on a sample recovered in the well 91.

In the case of the example shown in FIG. 10(B), the cartridge 90 is disposed between a light source 94, and a photo detector 95, and is irradiated by the light source 94, whereupon measurement light passing through the well 91 is detected by the photo detector 95. Thus, the cartridge is provided with the optical window for measurement, so that optical qualitative measurement and quantitative measurement can be implemented through the intermediary of light-absorption quantity, fluorescence quantity, and so forth.

If a region of the cartridge, structured so as to determine a sequence of a chemical treatment, is shielded with a light shielding member 92 as shown in FIGS. 10(A) and 10(B), effects of light on the chemical treatment can be avoided.

Relative position of the light source against the photo detector, or wavelength, and so forth of the measurement light can be selected as appropriate according to a purpose of measurement.

FIG. 10(C) shows an example for measuring polarized light, wherein a cartridge 90A is obliquely irradiated by a light source 94, and a photo detector 95 captures the polarized light. Further, FIG. 10(D) shows an example for measuring reflected light, wherein reflected light of light with which a cartridge 90B is irradiated by the light source 94 is captured by the photo detector 95 the polarized light. In this case, a light shielding member 92A black in color may be installed on the rear side of a measurement region of the cartridge.

As described in the foregoing, with the chemical treatment cartridge according to the invention, algorithm for separation of constituents is determined in advance due to a structure of the cartridge. Consequently, occurrence of failure or loss can be checked, and a difference in technical level among workers handling the cartridge will be less likely show up, so that a correct procedure for separation can be implemented at all times. Occurrence of careless accidents can be prevented. Further, preparation for a separation process is simple, and time and labor, necessary for separation, can be significantly reduced. Expensive wares which used to be required for separation of an object constituent will be no longer required. Furthermore, since the cartridge can be thrown away, a cleanup operation, such as cleaning of the wares, and so forth, is no longer required, so that it is possible to ensure safety for workers, and an ambient environment.

Still further since the cartridge can be kept in a hermetically sealed state, the same can be held in, for example, an anaerobic state, so that the cartridge is suitable for storage of refined products as well as the extracted object constituent. Yet further, solvent and other substances, required for extraction operation, but posing a problem with a storage condition thereof can be contained in the cartridge beforehand, so that a pre-extraction operation can be reduced.

The cartridge according to the invention can be put to widespread use for extraction of reagents for test purposes, and so forth. The cartridge according to the invention can also be widely used for manufacture and extraction of drugs, reagents, and other chemical constituents.

It is to be pointed out that the present invention is not limited in scope of application to working examples described hereinbefore. The invention can be widely applied to the chemical processing cartridge for executing separation of an object constituent by transferring contents thereof due to deformation occurring thereto, upon application of an external force thereto, and a method of using the same.

What is claimed is:

1. A chemical treatment cartridge for causing chemical treatment to proceed by transferring liquids contained therein due to deformation occurring thereto upon application of an external force thereto, said cartridge having an interior comprising:
an empty space for receiving a sample from outside; and
an empty space where a separation solvent for separating an object constituent contained in the sample as received is mixed with the sample, thereby separating the object constituent contained in the sample from other constituents.

2. The chemical treatment cartridge according to claim 1, wherein the interior of the cartridge comprises an empty space for causing reaction of the sample received from the outside to be stopped.

3. The chemical treatment cartridge according to claim 1, wherein the interior of the cartridge comprises an empty space for enriching the object constituent separated by the separation solvent.

4. The chemical treatment cartridge according to claim 1, wherein the object constituent is enriched due to evaporation of the solvent.

5. The chemical treatment cartridge according to claim 3, wherein the interior of the cartridge comprises an empty space for adding a dissolution agent to the enriched object constituent.

6. The chemical treatment cartridge according to claim 5, wherein the interior of the cartridge comprises an empty space for causing the object constituent to undergo recrystallization after addition of the dissolution agent.

7. The chemical treatment cartridge according to claim 6, wherein the object constituent is caused to undergo recrystallization due to evaporation of the dissolution agent, saturation accompanying cooling of the dissolution agent, or addition of a low solubility solvent.

8. The chemical treatment cartridge according to claim 6, wherein the interior of the cartridge comprises an empty space for cleaning the re-crystallized object constituent.

9. The chemical treatment cartridge according to claim 5, wherein the interior of the cartridge comprises a column for refining the object constituent by a chromatography after the addition of the dissolution agent.

10. The chemical treatment cartridge according to claim 9, wherein empty spaces for accommodating respective constituents discharged from the column on a split time basis may be formed.

11. The chemical treatment cartridge according to claim 1, wherein the interior of the cartridge is provided with an optical window for measurement, for executing optical measurement on contents of the cartridge.

12. The chemical treatment cartridge according to claim 1, wherein the interior of the cartridge comprises a plurality of predetermined structures formed so as to determine an identical sequence for the chemical treatment.

13. The chemical treatment cartridge according to claim 12, wherein the interior of the cartridge may comprise flow paths for branching the sample as received into the plurality of the predetermined structures.

14. The chemical treatment cartridge according to claim 1, wherein in the empty space where the object constituent contained in the sample is separated from other constituents, an oil layer may be separated from a water layer by the agency of gravity.

15. The chemical treatment cartridge according to claim 1, wherein in the empty space where the object constituent contained in the sample is separated from other constituents, the internal surface of the empty space may be provided with two regions differing from each other in respect of affinity against the object constituent, thereby effecting separation of the object constituent from other constituents.

16. A method of using a chemical treatment cartridge for causing chemical treatment to proceed by transferring liquids contained therein due to deformation occurring thereto upon application of an external force thereto, said method comprising:
a step of mixing a hydrophilic solvent, and a hydrophobic solvent, for separating an object constituent contained in a received sample, with the sample, in an empty space formed in the interior thereof, thereby separating the object constituent contained in the sample from other constituents; and
a step of discarding the cartridge used in the step of separating the object constituent contained in the sample from other constituents.
